(19) United States
(12) Patent Application Publication
(10) Pub. No.: US 2021/0324637 A1
(43) Pub. Date: Oct. 21, 2021

(54) Two Layers Wood Flooring and Processing Method

(71) Applicant: Fusong Jinlong Wooden Group Co.,ltd, Jilin Province (CN)

(72) Inventor: Wu Tong, Jilin Province (CN)

(73) Assignee: Fusong Jinlong Wooden Group Co.,ltd, Jilin Province (CN)

(21) Appl. No.: 16/852,273

(22) Filed: Apr. 17, 2020

(51) Int. Cl. E04F 15/04; B32B 3/14; B32B 7/12; B32B 21/13; B32B 37/12; B32B 37/18; B32B 38/00

(52) U.S. Cl. CPC E04F 15/045; B32B 3/14; B32B 7/12; E04F 15/02038; B32B 37/12; B32B 37/18; B32B 38/0004; B32B 21/13

(57) ABSTRACT

The invention relates to a double-layer wood engineered floor and method for making the same. The double-layer wood engineered floor comprises a plurality of front boards and a plurality of backboards, and each of the front board and each of the backboard are pasted together through an adhesive layer to form a double-layer wood structure. The double-layer wood engineered floor reduces the number of adhesive layers, that is, only one adhesive layer is used, which reduces the emission of harmful gases. The special structure of the backboard, that is, the horizontal and vertical staggered wood grain direction, greatly improves the structural stability of the double-layer wood engineered floor. It solves the problem that the other double-layer wood engineered floor has poor deformation resistance, and the problem that the traditional three-layer or multi-layer wood engineered floor has many adhesive layers, which releases excessive harmful gases.

### FIELD OF THE INVENTION

The present invention generally relates to a double-layer wood engineered floor and method for making the same, and especially to a double-layer wood engineered floor only uses one layer of glue to reduce the discharge capacity of pernicious gas.

### BACKGROUND OF THE INVENTION

With the continuous development of the solid wood engineered flooring industry, users are increasingly demanding the environmental performance of solid wood engineered flooring.

The traditional three-layer or multi-layer parquet technology is relatively complicated, and the adhesive layers in those structures often have the problem of excessive release of harmful gases.

Besides, the traditional double-layer wood engineered floor has the disadvantages of low longitudinal strength and the inability to process large-format floor due to its pure double-layer vertical and horizontal structure. The other traditional double-layer floor structure that has the feature of vertical or horizontal assembling backboard is easily cracked from the joint of the backboard when temperature or humidity changes, due to the direction of longitudinal joint on the backboard and the length direction of the floor are the same.

Therefore, there is a need for a method for making a double-layer solid wood engineered floor, which can solve the problem that the adhesive layers in the traditional three-layer or multi-layer engineered wood floor are excessive, which will release excessive harmful gas. It will also solve the problems that the surface of the front board is easily cracked from the joint when temperature or humidity changes, and the deformation resistance and the stress resistance of the traditional double-layer wood engineered floor are poor.

### SUMMARY OF THE INVENTION

The purpose of the present invention is to provide a double-layer wood engineered floor and method for making the same, which solves the problem of too many adhesive layers of traditional three-layer or multi-layer engineered wood floor and releases too much harmful gas, and simultaneously solves the problem problems that the surface of the front board is easily cracked when temperature or humidity changes, and the deformation resistance and the stress resistance of the traditional double-layer wood engineered floor are poor.

The present invention adopts the following technical solutions:

A method for making a double-layer wood engineered floor, comprising the steps of:

Step 1: use sawing, slicing, or rotary cutting to make wood into a plurality of front boards;

Step 2: perform the calibration, drying, and sizing procedures on the front boards in step 1 to obtain a plurality of prepared front board;

Step 3: use sawing, slicing, or rotary cutting to make wood into a plurality of wood boards;

Step 4: cut the wood boards into a plurality of strips, a plurality of first blocks and a plurality of second blocks;

Step 5: assemble the strips, the first blocks and the second blocks to form a plurality of backboards; wherein the strips are located at two sides of each of the backboard, the first blocks and the second blocks are in stagger arrangement between the strips, and wood grain of the first blocks is perpendicular to wood grain of the second blocks;

Step 6: perform the slicing procedure and calibration on the backboards in step 5, and glue one side of each of the backboard to form an adhesive layer;

Step 7: stick each of the backboard in the step 6 and each of the prepared front board together through a pressing procedure to form a plurality of double-layer wood structures; wherein wood grain of the prepared front boards is same as the wood grain of the strips;

Step 8: perform the calibrating, profiling and finishing procedures on the double-layer wood structures in step 7 to form a plurality of floor blocks; and

Step 9: assemble the floor blocks through tongue and groove joint to form the double-layer wood engineered floor.

In some embodiments, the way to assemble the strips, the first blocks, and the second blocks in step 5 can be finger joint or flat joint.

In some embodiments, the size of the first blocks and the size of the second blocks may be different.

A double-layer wood engineered floor, comprising:

a plurality of floor blocks, comprising:
a plurality of front boards; and
a plurality of backboards, wherein each of the backboard is assembled by a plurality of strips, a plurality of first blocks and a plurality of second blocks, and the strips are located at two sides of each of the backboard, the first blocks and the second blocks are in stagger arrangement between the strips, and wood grain of the first blocks is perpendicular to wood grain of the second blocks;
wherein an adhesive layer is attached to one side of each of the backboard, and each of the backboard having the adhesive layer is stick with each of the front board stick through a pressing procedure to form a plurality of double-layer wood structures, and the double-layer wood structures go through calibrating, profiling and finishing procedures to form the floor blocks.

The advantages of the invention are as follows:

1. The grain direction of the backboard and the grain direction of the front board are the same in most areas, and the grain direction of the first block is perpendicular to the grain direction of the second block, these features greatly reduces the problem of non-uniform deformation between these two, and it will also offsets the internal stress to increase the ability of longitudinal deformation resistance, which enable to make processing on the floors that have large areas.

2. The amount of adhesive layer in the double-layer wood engineered floor is reduced to only one, which will also reduce the emission of harmful gases.

### BRIEF DESCRIPTION OF THE DRAWINGS

It should be noted that the drawing figures may be in simplified form and might not be to precise scale. In reference to the disclosure herein, for purposes of convenience and clarity only, directional terms such as top, bottom, left, right, up, down, over, above, below, beneath, rear, front, distal, and proximal are used with respect to the accompanying drawings. Such directional terms should not be construed to limit the scope of the embodiment in any manner.

FIG. 1 illustrates a schematic view of the cross section of the floor block that can be assembled to form the double-layer wood engineered floor.

FIG. 2 illustrates a bottom view of the floor block that can be assembled to form the double-layer wood engineered floor to show the structure of backboard.

FIG. 3 illustrates a bottom view of another embodiment of the floor block that can be assembled to form the double-layer wood engineered floor to show the structure of backboard.

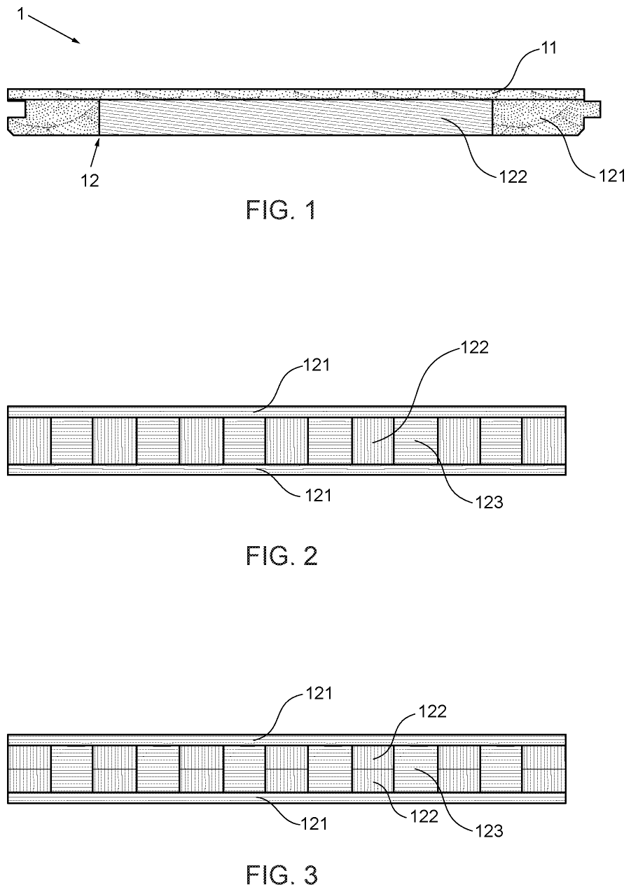

### DETAILED DESCRIPTION OF THE INVENTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims.

A double-layer wood engineered floor, comprising:

a plurality of floor blocks 1, comprising:
a plurality of front boards 11; and
a plurality of backboards 12, wherein each of the backboard is assembled by a plurality of strips 121, a plurality of first blocks 122 and a plurality of second blocks 123, and the strips 121 are located at two sides of each of the backboard 12, the first blocks 122 and the second blocks 123 are in stagger arrangement between the strips 121, and wood grain of the first blocks 122 is perpendicular to wood grain of the second blocks 123;
wherein an adhesive layer is attached to one side of each of the backboard 12, and each of the backboard 12 having the adhesive layer is stick with each of the front board 11 stick through a pressing procedure to form a plurality of double-layer wood structures, and the double-layer wood structures go through calibrating, profiling and finishing procedures to form the floor blocks 1.

Besides, there's a method for making a double-layer wood engineered floor, comprising the steps of:

Step 1: use sawing, slicing, or rotary cutting to make wood into a plurality of front boards;

Step 2: perform the calibration, drying, and sizing procedures on the front boards in step 1 to obtain a plurality of prepared front board 1;

Step 3: use sawing, slicing, or rotary cutting to make wood into a plurality of wood boards;

Step 4: cut the wood boards into a plurality of strips 121, a plurality of first blocks 122 and a plurality of second blocks 123;

Step 5: assemble the strips 121, the first blocks 122 and the second blocks 123 to form a plurality of backboards 12; wherein the strips 121 are located at two sides of each of the backboard 12, the first blocks 122 and the second blocks 123 are in stagger arrangement between the strips 121, and wood grain of the first blocks 122 is perpendicular to wood grain of the second blocks 123;

Step 6: perform the slicing procedure and calibration on the backboards 12 in step 5, and glue one side of each of the backboard 12 to form an adhesive layer;

Step 7: stick each of the backboard 12 in the step 6 and each of the prepared front board 11 together through a pressing procedure to form a plurality of double-layer wood structures; wherein wood grain of the prepared front boards is same as the wood grain of the strips;

Step 8: perform the calibrating, profiling and finishing procedures on the double-layer wood structures in step 7 to form a plurality of floor blocks 1; and

Step 9: assemble the floor blocks 1 through tongue and groove joint to form the double-layer wood engineered floor.

In this embodiment, the way to assemble the strips 121, the first blocks 122, and the second blocks 123 in step 5 is finger joint or flat joint, and the size of the first blocks 122 and the size of the second blocks 123 are not different, but it can also be different (such as the size of each of the second block 123 is twice bigger than each of the first blocks 122) like FIG. 3 demonstrates, so it's not limited. Moreover, because the size of the first blocks 122 and the size of the second blocks 123 are different, the total amount of blocks (including first blocks 122 and second blocks 123) is greater than another embodiment. That will further increase the structural strength of the backboard 12 and decrease the uneven stress since there are more blocks that can be used to assemble the backboard 12 while in the same volume of the backboard 12, and the stress would be lower when assembling the first blocks 122 and the second blocks 123 base on the perpendicular wood grain in this embodiment.

The structure and the method given above overcome the problem of uneven stress release of traditional double-layer wood engineered floors, because the backboard 12 is composed of the first blocks 122 and the second blocks 123, and the grain direction of the first blocks 122 are perpendicular to the grain direction of the second blocks 123, these features will effectively prevent the problem of horizontal bending deformation appears at the joint between the backboard 12 and the front board 11, or even cracking on the front board 11 due to changes in humidity or temperature.

Because it effectively controls the problems of its deformation and low longitudinal strength, it can also effectively increase the area of the floor making to 2200 mm long and 320 mm wide. By making a large-area floor, it can simplify the process, reduce costs and make the product beautiful, elegant and high added value.

Moreover, this structure uses only one adhesive layer which reduces a large amount of the emissions of harmful gases, while the prior art uses three or more adhesive layers which would release excessive amount of harmful gases.

1. A method for making a double-layer wood engineered floor, comprising the steps of:
Step 1: use sawing, slicing, or rotary cutting to make wood into a plurality of front boards;
Step 2: perform the thickness fixing, drying, and sizing procedures on the front boards in step 1 to obtain a plurality of prepared front boards;
Step 3: use sawing, slicing, or rotary cutting to make wood into a plurality of wood boards;
Step 4: cut the wood boards into a plurality of strips, a plurality of first blocks and a plurality of second blocks;
Step 5: assemble the strips, the first blocks and the second blocks to form a plurality of backboards; wherein the strips are located at two sides of each of the backboard, the first blocks and the second blocks are in stagger arrangement between the strips, and wood grain of the first blocks is perpendicular to wood grain of the second blocks, wherein any one of the first blocks will not touch another of the first blocks and any one of the second blocks also will not touch another of the second blocks in stagger arrangement between the strips;
Step 6: perform the calibration on the backboards in step 5, and glue one side of each of the backboard to form an adhesive layer;
Step 7: stick each of the backboard in the step 6 and each of the prepared front board together through a pressing procedure to form a plurality of double-layer wood structures; wherein wood grain of the prepared front boards is same as the wood grain of the strips; wherein the amount of the adhesive layer in each of the double-layer wood structures is only one; and
Step 8: perform the calibrating, profiling and finishing procedures on the double-layer wood structures in step 7 to form a plurality of floor blocks.

2. The method for making a double-layer wood engineered floor, as recited in claim 1, wherein the way to assemble the strips, the first blocks, and the second blocks in step 5 is finger joint or flat joint.

3. The method for making a double-layer wood engineered floor, as recited in claim 1, wherein the size of the first blocks and the size of the second blocks are different.

4. A double-layer wood engineered floor, comprising:
a plurality of floor blocks, comprising:
a plurality of front boards; and
a plurality of backboards, wherein each of the backboard is assembled by a plurality of strips, a plurality of first blocks and a plurality of second blocks, and the strips are located at two sides of each of the backboard, the first blocks and the second blocks are in stagger arrangement between the strips, and wood grain of the first blocks is perpendicular to wood grain of the second blocks;
wherein any one of the first blocks will not touch another of the first blocks and any one of the second blocks also will not touch another of the second blocks in stagger arrangement between the strips;
wherein an adhesive layer is attached to one side of each of the backboard, and each of the backboard having the adhesive layer is attached with each of the front board through a pressing procedure to form a plurality of double-layer wood structures, and the double-layer wood structures go through calibrating, profiling and finishing procedures to form the floor blocks;
wherein the amount of the adhesive layer in each of the double-layer wood structures is only one.
